(19) United States
(12) Patent Application Publication
(10) Pub. No.: US 2003/0133755 A1
(43) Pub. Date: Jul. 17, 2003

(54) Method of removing contaminants from a contaminated earth mass

(76) Inventor: Choong Hee Rhee, Long Beach, CA (US)

Correspondence Address: ERIK M. ARNHEM, U.S.A., Second Floor, 4250 Wilshire Blvd., Los Angeles, CA, 90010, US

(21) Appl. No.: 10/046,050

(22) Filed: Jan. 15, 2002

(51) Int. Cl. B09C 1/02

(52) U.S. Cl. 405/128.25; 405/128.5

(57) ABSTRACT

Toxic contaminants dispersed throughout a section of earth can be removed by a process that includes applying liquid hydrogen peroxide to the earth surface, and exerting a vacuum force on the earth at a depth where the earth is relatively uncontaminated. The vacuum force evacuates the earth pores, to augment the gravitational force on the liquid hydrogen peroxide, so that the liquid is enabled to flow through the earth to chemically react with toxic contaminants. One or more vacuum pumps are connected with underground perforated pipes bordering the treated earth section, to produce the necessary vacuum force on the liquid hydrogen peroxide.

### FIELD OF THE INVENTION

This invention relates to an in-situ method of removing toxic contaminates from a contaminated section of earth, e.g. earth contaminated with dsipersed gasoline, diesel fuel or dry cleaning fluid. The invention is useful at gasoline stations, dry cleaning facilities, or other industrial locations where toxic substances can accumulate underground over time.

### BACKGROUND OF THE INVENTION

Under conventional practice, toxic substances can be removed from the earth by excavating the earth surface to a necessary depth, and replacing the excavated soil with clean (uncontaminated) soil. The excavitated soil has to be treated chemically or isolated from the atmosphere by encasement.

Another proposed system utilizes a soil vapor extraction system that uses vacuum as the extraction force.

Ground water has been treated by pumping oxygen or air into the ground so as to purge the otherwise inaccessible water of contaminants. In some cases the ground water has been pumped out of the ground and then treated with carbon. The known prior art systems are relatively expensive for the owner of the facility being treated.

### SUMMARY OF THE INVENTION

The present invention relates to a method of removing toxic contaminants from a section of contaminated earth by injecting hydrogen peroxide into the earth, whereby the hydrogen peroxide chemically reacts with contaminants to form relatively harmless reaction products.

A vacuum force is applied to perimeter areas of the affected earth mass for the purpose of improving the extraction process, and also for the purpose of removing the reaction products. As the earth mass becomes saturated with the hydrogen peroxide and reaction products, the vacuum force removes gases and/or liquids from the earth mass, thereby enabling new hydrogen peroxide to enter into the earth pores for continuing the process.

Specific features of the invention will be apparent from the attached drawings and description of a particular apparatus that can be used to practice the invention.

### BRIEF DESCRIPTION OF THE DRAWINGS

FIG. 1 is a sectional view, taken on line 1-1 in FIG. 2, showing one apparatus usable in practice of the invention.

FIG. 2 is a top plan view of the FIG. 1 apparatus.

### DESCRIPTION OF A PREFERRED APPARATUS FOR PRACTICING THE INVENTION

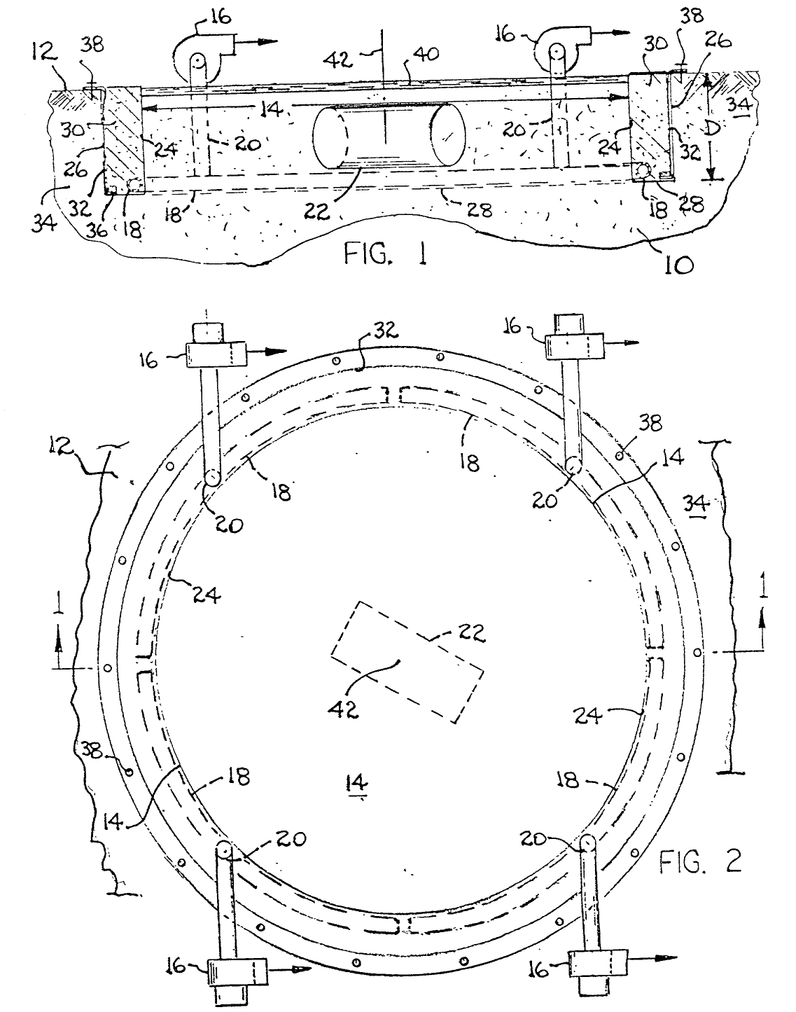

Referring to FIGS. 1 and 2, there is shown an earth mass 10 having a surface 12. Section 14 of the earth mass is assumed to be contaminated with dispersed contaminants down to a depth denoted by dimension D in FIG. 1. Under the present invention, earth section 14 is injected or impregnated with liquid hydrogen peroxide, whereby the dispersed toxic contaminants react with the/peroxide to form relatively harmless reaction products. The reaction products are removed from the treated earth section by the application of a vacuum force to border areas of the treated earth section. As shown in FIGS. 1 and 2, the vacuum force is applied by four above-ground vacuum pumps 16. Each pump is connected to an underground perforated pipe 18 by means of a riser pipe (or conduit) 20, whereby liquids and vapors are drawn upwardly out of the perforated pipe.

Hydrogen peroxide is chemically reactive with various toxic substances, including various sulfides, nitrides, saturated hydrocarbons, and unsaturated hydrocarbons. The reaction products are relatively harmless gases and liquids that can be removed from the treated earth section by vacuum pumps 16, when needed.

Hydrogen peroxide reacts with benzene according to the following equation: C₆H₆+13H₂O₂=6CO₂+14H₂O+2H₂ On the left side of the equation C₆H₆ is toxic, 13 H₂O₂ may remain in the soil; the right side of the equation is none-toxic. Hydrogen peroxide reacts with tetrachloroethylene according to the following equation: C₂Cl4+2H₂O₂=2CO₂+4HCl. On the left side of the equation C₂Cl₄ is toxic; 2H₂O₂, will disappear. On the right side of the equation 2CO₂+4HCL is non-toxic, and may stay in soil.

Benzene is a constituent in gasoline. Tetrachloraethylene is used for dry cleaning clothes. The present invention can be used for removing toxic components from contaminated earth in various industrial locations, e.g. gasoline stations or dry cleaning facilities. In FIGS. 1 and 2 an underground fuel storage tank 22 is shown as the contamination source for the contaminants dispersed throughout earth section 14 that is to be treated by the present invention.

The geographical character of the treated earth section 14 (size and shape) will usually be determined by taking core samples of the suspected area. In FIGS. 1 and 2 the treated earth section 14 is cylindrical. However, the shape and depth of the treated section can vary, from one situation to another.

Treated earth section 14 has a border or perimeter that is circumscribed by the aforementioned perforated pipe 18. In this case pipe 18 completely encircles the treated earth section 14 on a horizontal plane at depth D. Depth dimension D is determined (by core sampling) as the vertical extent of the toxic contamination. The earth volume below depth D is assumed to be uncontaminated.

In the illustrated arrangement, perforated pipe 18 is subdivided into four separate pipe sections, each pipe section occuppying one quadrant of the perimeter space bordering treated earth section 14. The ends of each pipe section are sealed so that fluids can enter each pipe section only through the pipe perforations that are equidistantly spaced along the respective pipe section length.

Conventional perforated drainage pipe can be used. Such pipe commonly takes the form of a thin wall corrugated plastic pipe that is flexible (or bendable) so as to follow the trench used to contain the pipe. The corrugated perforated pine is ususally encased in a cheese cloth covering designed to prevent solid particulates from clogging or closing the pipe perforations.

As shown in FIG. 2, each perforated pipe section connects with one of the four vacuum pumps 16, via an associated riser pipe 20. With such an arrangement, each pump exerts a vacuum force on only one quadrant of the treated earth section 14. The four vacuum pumps can be operated in unison or selectively on a programmed basis, to vary or target the vacuum force to specific areas of earth section 14.

As previously indicated, perforated pipe 18 is located in a trench formed in the earth. This annular trench has an inner annular vertical surface 24, outer annular vertical surface 26, and bottom surface 28. Pipe 18 is layed on the trench bottom surface, after which the trench is closed with fill dirt, designated by numeral 30 in FIG. 1.

In order to confine the vacuum force of the pipe 18 perforations to the circumscribed earth section 14, the outer surface 26 of the trench may be coated with a barrier material 32 extending the full depth dimension D. Barrier 32 isolates earth section 14 from the surrounding earth area 34, so that the vacuum force of the pipe 18 perforations is applied only to earth section 14, not the surrounding earth area 34.

Barrier 32 can take various forms. For example, flexible plastic sheeting can be hung or suspended from earth surface 12 downwardly along trench surface 26. Planks 36 can be used to anchor the lower ends of the plastic sheeting. Stakes 38 can be used to anchor the upper ends of the plastic sheeting. The barrier (e.g. sheeting) extends along the entire circumferential dimension of trench surface 26, to isolate earth section 14 from the surrounding earth area 34. The barrier is formed prior to the operations of laying the perforated pipe 18 and adding the fill dirt.

The liquid hydrogen peroxide may be injected into earth section 14 by flooding the upper surface of earth section 14 with the liquid reagant, to a depth sufficient to saturate the treated earth section. In FIG. 1, numeral 40 designates the layer of hydrogen peroxide that floods the upper surface of earth section 14. The liquid reagant migrates downwardly (gravitationally) through pores in the earth to chemically react with toxic contaminants in the earth.

Porosity of the earth is usually not sufficient by itself to produce a satisfactory downflow of hydrogen peroxide. Usually it is necessary to augment the gravitational force with a vacuum force (produced by pumps 16). In one procedure, pumps 16 are activated prior to the operation of flooding the earth surface with liquid hydrogen peroxide. The vacuum forces produce a relatively even evacuation of the earth pores (measured horizontally) so that when the liquid is applied to the earth surface the liquid downflow through the earth is relatively even across the horizontal plane, even though the vacuum force is exerted at the border of the treated earth section.

The vacuum pumps 16 can be intermittently de-activated to permit the saturating liquid to chemically react with toxic contaminants. Periodically the pumps can be reactivated to remove liquid and/or gaseous reaction products from the treated earth section 14, thereby permitting additional liquid hydrogen peroxide to be added to liquid layer 40. The process is repeated until core sampling indicates that the toxic contaminant values are reduced to a desired safe level.

The contaminant concentration will not necessarily be uniform across the lateral dimension of earth section 14. For example, the contaminant concentration could be relatively high in the northeast quadrant and relatively low in the other quadrants of earth section 14 (as viewed in FIG. 2). In such a situation the pump 16 associated with the northeast quadrant would be selectively activated, leaving the other pumps in the de-activated states. The vacuum force would thereby be concentrated or applied primarily in the earth section where liquid treatment is most needed.

Toxic contaminants relatively close to central axis 42 of earth section 14 may be subjected to opposing forces when all pumps 16 are in operation. By selectively activating only one of the pumps it is possible to eliminate, or minimize the opposing force on contaminants or liquids located in the vicinity of central axis 42, thereby improving the contaminant removal process.

By way of summarization, the invention contemplates a method of removing toxic contaminants from a predetermined earth section (or mass) 14 by flowing liquid hydrogen peroxide downwardly through the earth pores to a desired dimension D. Underground perforated pipes 18 located along the border of the treated earth section exert vacuum forces that augment the gravitational force, whereby liquid hydrogen peroxide relatively evenly saturates the earth pores. Reaction products are withdrawn by the vacuum pump(s), to keep the process ongoing. Pumps 16 can be selectively activated to produce selected liquid flows through different areas of the earth mass where contaminant concentrations may be relatively high.

The drawings and description relate to one particular apparatus that can be used to practice the invention. However, it will be appreciated that various different treatment apparatus and procedures can be used while still practicing the invention.

What is claimed:

1. A method of removing toxic contaminants from a predetermined earth mass, comprising:
(a) positioning a perforated pipe underground along the border of a contaminated earth mass;
(b) flooding the surface of the contaminated earth mass with liquid hydrogen peroxide so that the liquid gravitates into the contaminated earth for chemical reaction with toxic contaminants; and
(c) applying a vacuum to the underground perforated pipe.

2. The method of claim 1, wherein the step of applying a vacuum to the perforated pipe includes applying a first vacuum force to the perforated pipe prior to the liquid flooding step, and applying a second vacuum force to the perforated pipe after the liquid flooding step, the use of vacuum being only applicable when needed.

3. The method of claim 1, wherein the step of positioning the perforated pipe involves digging a trench in the earth surface, and laying a perforated pipe in the trench.

4. The method of claim 1, wherein the step of positioning the perforated pipe involves digging an annular trench in the earth surface around the contaminated earth mars, and laying a perforated pipe in the trench so that the pipe forms an endless channel circumscribing the contaminated earth mass.

5. The method of claim 1, wherein the step of applying a vacuum to the perforated pipe is carried out with at least one vacuum pump located above the earth surface, if needed.

6. A method of removing toxic contaminants from a predetermined earth section comprising:
(a) circumscribing a contaminated earth section with an endless barrier extending downwardly from the earth surface, so that an inner surface of the barrier faces the contaminated earth section;
(b) positioning at least one perforated pipe along the inner surface of the barrier so that the pipe perforations are in fluid communication with the contaminated earth section;
(c) flooding the surface of the contaminated earth section with liquid hydrogen peroxide so that the liquid gravitates into the contaminated earth for chemical reaction with toxic contaminates; and
(d) applying a vacuum to the perforated pipe.

7. The method of claim 6, wherein the pipe positioning step includes forming a trench in the earth, and laying the perforated pipe in the trench.

8. The method of claim 6, wherein the step of circumscribing a contaminated earth section with an endless barrier, includes forming a trench in the earth to provide a trench bottom surface, a trench inner surface, and a trench outer surface; and coating the trench outer surface with a barrier material.

9. The method of claim 8, wherein the pipe positioning step includes laying the perforated pipe on the bottom surface of the trench.

10. The method of claim 9, wherein the step of applying a vacuum to the perforated pipe includes extending at least one riser pipe upwardly from said perforated pipe, and connecting a vacuum pump to the riser pipe.

11. The method of claim 6, wherein the step of applying a vacuum to the perforated pipe includes locating at least one vacuum pump on the earth surface, and extending a conduit from the perforated pipe to the pump.
